(19) United States
(12) Patent Application Publication
(10) Pub. No.: US 2006/0274796 A1
(43) Pub. Date: Dec. 7, 2006

(54) Real-time sensors for lasers

(76) Inventors: Hengju Cheng, Mountain View, CA (US); Tom Mader, Los Gatos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/479,541

(22) Filed: Jun. 30, 2006

Related U.S. Application Data
(63) Continuation-in-part of application No. 11/008,905, filed on Dec. 10, 2004.

(51) Int. Cl. H01S 3/13; H01S 3/00

(52) U.S. Cl. 372/29.021; 372/29.02; 372/38.01; 372/38.02

(57) ABSTRACT

Methods of sensing lasers in real time for monitoring and control are disclosed. In one aspect, a method may include applying a perturbation current to a laser for a plurality of consecutive modulation cycles. Power of light emitted by the laser over the plurality of consecutive modulation cycles may be detected. Then, the perturbation current may be changed. The power of light emitted by the laser over a plurality of consecutive modulation cycles may be detected after changing the perturbation current. Then, an operating characteristic of the laser may be determined based, at least in part, on a change in the power of light detected before and after the change in the perturbation current. Sensors and systems incorporating the sensors are also disclosed.

### RELATED APPLICATIONS

The present application is a continuation-in-part of U.S. patent application Ser. No. 11/008,905, filed Dec. 10, 2004, entitled “REAL TIME CONSTANT EXCITATION RATIO (ER) LASER DRIVING CIRCUIT”, by Chien-Chang Liu and Hengju Cheng, which is currently pending. The U.S. patent application Ser. No. 11/008,905 is incorporated herein by reference.

### FIELD OF THE INVENTION

Embodiments of the present invention relate to lasers and, more particularly, to monitoring and controlling a laser in real time.

### BACKGROUND INFORMATION

Lasers are used in a wide variety of applications. In particular, lasers are integral components in optical communication systems where a beam modulated with vast amounts of information may be communicated great distances at the speed of light over optical fibers as well as short reach distances such as from chip-to-chip in a computing environment.

Of particular interest is the so-called vertical cavity surface emitting laser (VCSEL). As the name implies, this type of laser is a semiconductor micro-laser diode that emits light in a coherent beam orthogonal or “vertical” to the surface of a fabricated wafer. VCSELs are compact, relatively inexpensive to fabricate in mass quantities, and may offer advantages over edge emitting lasers which currently comprise the majority of the lasers used in today's optical communication systems. The more traditional type edge emitting laser diodes emit coherent light parallel to the semiconductor junction layer. In contrast, VCSELs emit a coherent beam perpendicular to the boundaries between the semiconductor junction layers. Among other advantages, this tends to make it easier to couple the light beam to an optical fiber.

VCSELs may be efficiently fabricated on wafers using standard microelectronic fabrication processes and, as a result, may be integrated on-board with other components. VCSELs may be manufactured using, for example, aluminum gallium arsenide (AlGaAs), gallium arsenide (GaAs), indium gallium arsenide nitride (InGaAsN), or similarly suited materials. VCSELS have been successfully manufactured in 850 nm, 1310 nm and 1550 nm ranges. This allows for a wide variety of fiber optic applications ranging from short reach applications to long haul data communications. VCSELs are promising to advance optical communication systems by providing a fast, inexpensive, energy efficient, and more reliable source of laser beam generation.

Optical transceivers using VCSELs operating at line rates of 10 gigabits/second (Gb/s) have matured rapidly over the last few years and are currently available in a wide variety of form factors, each addressing a range of link parameters and protocols. These form factors are the result of Multi-Source Agreements (MSAs) that define common mechanical dimensions and electrical interfaces. The first MSA was the 300-pin MSA in 2000, followed by XENPAK, X2/XPAK, and XFP. Each of the transceivers defined by the MSAs has unique advantages that fit the needs of various systems, supporting different protocols, fiber reaches, and power dissipation levels.

Temperature affects the performance of VCSELs. Nevertheless, optical transceivers are expected to operate across a wide ambient temperature range. For example, some of the MSAs may call for the transceiver to operate in conditions as cold as −25° Celsius to as hot as 85° Celsius. In optical transceiver circuits, one common problem encountered may be the change of laser ER (extinction ratio) with temperature changes. When electrons at energy level N₁ are moved to higher energy level, N₂, energy is absorbed. When the electrons at energy level N₂ drop to level N₁, light is emitted. The ratio of electron quantity n₂ at energy level N₂ to a total electron quantity (n1+n2) at energy levels N1 and N2 may be called the excitation ratio (ER).

VCSELs have the ER characteristics as shown in FIG. 1. At lower temperatures, the slope efficiency is high. As the ambient temperature increases to higher temperatures, the slope efficiency drops and the turn on threshold current also increases. In order to compensate for this effect, the laser driving current may be increased as temperature rises.

One way to determine the amount by which to modify drive current for a given temperature change may be to record the laser driving conditions in a memory (e.g. an EEPROM) for different temperature conditions. A driver determines the level of current to provide by referencing the look-up table in the memory to thus to compensate for the drop in slope efficiency. However, in real-world manufacturing, the manufacturer may only have one look up table to fit all different laser characteristics, which may vary due to operating conditions, age, and manufacturing variances. Hence, a laser using a “one size fits all” look-up table to determine operating conditions may tend to be inaccurate.

### BRIEF DESCRIPTION OF THE DRAWINGS

FIG. 1 graph plotting laser power vs. drive current illustrating the change in excitation ratio (ER) slope for a vertical cavity surface emitting laser (VCSEL) operating in a lower temperature and higher temperature;

FIG. 2 is a plan view of a small form factor (SFF) optical transceiver package according to embodiments of the invention;

FIG. 3 is a cut-away side view of a transmitter optical sub-assembly (TOSA) which may comprise the transmitter portion of the SFF shown in FIG. 2;

FIG. 4 is a plan view of a TO-can comprising part of the TOSA;

FIG. 5 is a block diagram showing the drive control for the TOSA;

FIG. 6 is a graph illustrating periodically increasing and decreasing the current code to a digital-analog current (DAC) source by ±1 least significant bit (LSB) to determine the excitation ratio of a VCSEL in real time;

FIG. 7 is a block diagram of a parallel optics module implementing one embodiment of the invention;

FIG. 8 is a block diagram of an optical router implementing the VCSEL and control scheme in one embodiment of the invention;

FIG. 9 is a block diagram of an optical transmitter, according to one or more embodiments of the invention;

FIG. 10A-C show how slope efficiency may be determined, according to one or more embodiments of the invention;

FIG. 11 is a graph illustrating roll over, according to one or more embodiments of the invention;

FIG. 12A-C show how roll over may be determined, according to one or more embodiments of the invention; and

FIG. 13A-C show how pulse width distortion may be determined, according to one or more embodiments of the invention.

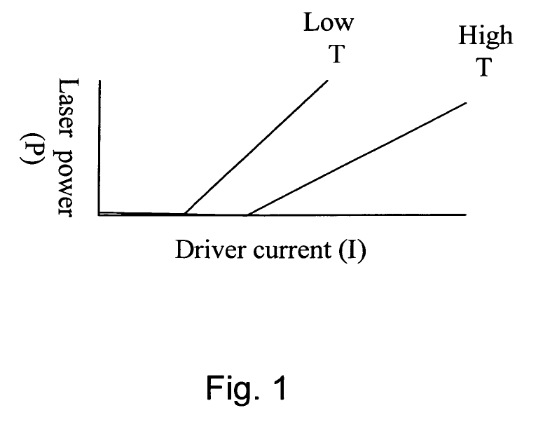

### DETAILED DESCRIPTION

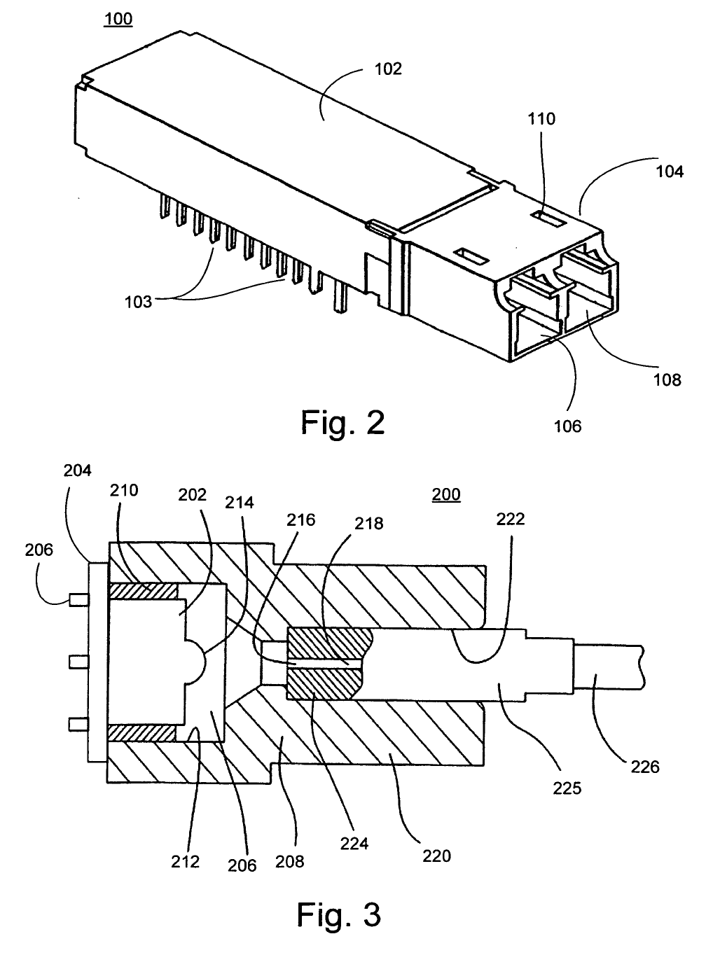

Modem Small Form Factor (SFF) Optical Transceivers provide high performance integrated duplex data links for bi-directional communication over multimode optical fiber. FIG. 2 shows one type of an SFF optical transceiver package 100. The package may comprise a body 102 for housing electronic and optoelectronic components. Pins 103 may be provided on the body 102 for attachment to a circuit board. The front of the package 100 may include a receptacle portion 104 to receive a mating plug (not shown) to connect optical fibers or waveguides to the transceiver package 100. In this example a transmitter receptacle 106 and a receiver receptacle 108 are shown. Slots 110 or similar features may be present to provide a locking mechanism for a mating plug.

Referring to FIG. 3, within the transmitter receptacle 106 of FIG. 2, there may be a transmitter optical sub-assembly (TOSA) 200. While the TOSA may take many configurations, the one illustrated in FIG. 2 comprises what may be known as a transistor-outline can (TO-can) package 202. This name refers to the shape of the TO-can 202 that resembles the shape of a discrete transistor package. The TO-can 202 hermetically houses sensitive components of the TOSA 200. The TO-can 202 may comprise a header portion 204 having electrical leads 206. The TO-can 202 fits within a cavity 206 with the header 204 abutting against an outer housing 208. A spacer 210 may be used to hold the TO-can 202 against the inner walls 212 of the cavity 206. A lens or window 214 in the top of the TO-can 202 allows light to pass to or from and optical fiber core 216. The housing 208 is adapted to align the optical fiber 218 to the window 214 of the TO-can 202. While the TO-can 202 is shown as a convex lens 214, the TO-can 202 may comprise a metal can with a flat angled window. The housing 208 may form the female portion 220 of a small form factor (SFF) pluggable connector, such as an LC connector, or other standardized removable connector for optical transceivers. The fiber 218 has an extending cord section 226 and may further comprise an outer protective sheathing 224 that is held by the mating portion of the connector comprising a ferrule 225 centering the fiber 218. The ferrule 225 may be plugged into a ferrule receptacle 222 formed in the housing 208 such that the fiber 218 is optically aligned with the window 214 of the TO-can 202.

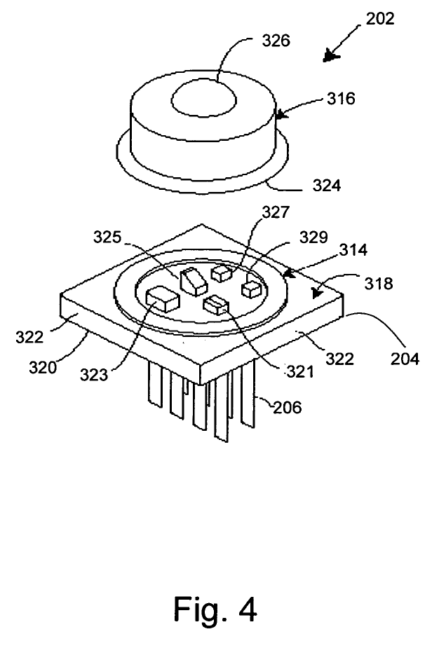

FIG. 4 shows a more detailed view of the TO-can 202 for housing an optoelectronic assembly. The To-can 220 may include insulating base or header 204, a metal sealing member 314, and a metal cover 316. Preferably, the header 204 is formed of a material with good thermal conductivity for directing dissipated heat away from the optoelectronic assembly. By using a high thermal conductivity material, the header 12 may effectively dissipate the heat of un-cooled active optical devices, e.g., diode lasers, and can incorporate integrated circuits, such as diode driver chips.

The insulating header 204 includes an upper surface 318, a lower surface 320, and four substantially flat sidewalls 322 (two of which are shown) extending downwardly from the upper surface 318. The thickness of the header 204 may be approximately 1 mm. Of course, it should be understood that the insulating header 204 may be thicker or thinner as desired. The header 204 may be configured as a multilayer substrate having a plurality of levels. Multiple metal layers may be provided at each of the plurality of levels, and joined together (e.g., laminated).

Various devices may be housed within the TO-can 202. For example, an active optical device 321, such as a VCSEL 321, and its associated integrated circuitry 323, other optical devices 325, such as a photodiode 325, and various other electrical components 327 and 329 may be located within an inner region of the metal sealing member 314.

At least one electrical lead 206 may be included adapted to communicate signals from the optoelectronic and/or electrical components housed inside the package TO-can 202 to components located external to the TO-can 202 on a printed circuit board, for example. The leads 206 may be circular or rectangular in cross-section, as shown. Alternatively, the header 204 may be operatively coupled to a printed circuit board using solder connections such as, for example, ball grid array connections and/or a flex circuit.

The cover 316, may be formed of Kovar™ or other suitable metal, may be hermetically sealed to the metal sealing member 314 to contain and fully enclose the optoelectronic and electrical components mounted to the upper surface 318 of the header 204, and to thereby seal off the TO-can 202. Use of such a hermetically sealed cover 216 acts to keep out moisture, corrosion, and ambient air to protect the generally delicate optoelectronic and electrical components therein.

The cover 316 includes a transparent portion 214 such as, for example, a flat glass window, ball lens, aspherical lens, or GRIN lens. The optoelectronic components, such as the VCSEL 325, are positioned within the TO-can 202 in a manner such that light is able to pass to or from them through the transparent portion 214. Typically, the transparent portion 214 is formed of glass, ceramic, or plastic. To avoid effecting the optoelectronic and electrical components housed within the TO-can 202, the transparent portion 214 of the cover 316 may be provided with an antireflection coating to reduce optical loss and back-reflection.

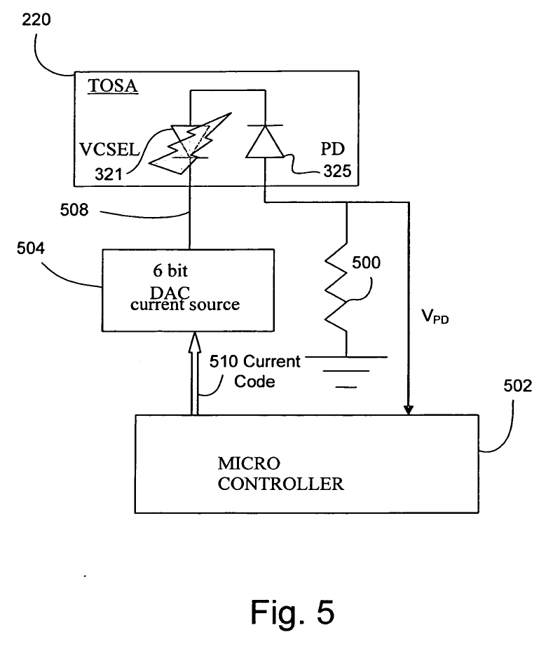

FIG. 5 shows a block diagram of a laser driving circuit according to one embodiment of the invention to determine the laser's excitation ratio (ER) slope in real time in order to adjust parameters to keep the slope substantially constant even as extraneous parameters, such as ambient temperature, varies. In one embodiment, a VCSEL laser 321 may be fashioned in a TOSA 220, such as that shown in FIG. 3, and form part of an optical transceiver 100 such as that shown in FIG. 2. A photo detector (PD) 325 may also be fashioned in the TOSA 220 to detect the output of the VCSEL 321. The photo detector (PD) 325 outputs a signal in response to the detected output of the VCSEL 321. In one embodiment, the output of the PD 325 may be measured by monitoring changes in a voltage V_{PD} across a resistor 500 by a microcontroller 502.

In one embodiment, a digital-to-analog current source (DAC) 504 may be used to provide a drive current to the VCSEL 231. DAC current sources are generally discussed for example in U.S. Pat. No. 5,001,484 to Weiss. The DAC current source 504 may typically be constructed of an array of current source transistors that produce output currents of weighted values that represent bits in a binary word or code 510. High resolution DACs typically employ weighted current sources in which the ratio of the most significant current bit I_{MSB}, to the least significant current bit, I_{LSB}, ranges from 64:1, in the case of an six-bit DAC, to as high as 32,768:1, in the case of a sixteen-bit DAC. In general terms, I_{MSB}/I_{LSB}=2^{(N-1)}, where N is the number of bits.

In one embodiment, as shown in FIG. 5, a 6-bit DAC current source 504 may be used. As shown, the VCSEL driving current 508 may be selected by inputting a 6-bit binary code 510 into the 6-bit DAC 504. The output power of the VCSEL 321 may be monitored by the voltage V_{PD} from the photo detector (PD) 325 which may be located inside the TOSA package 220.

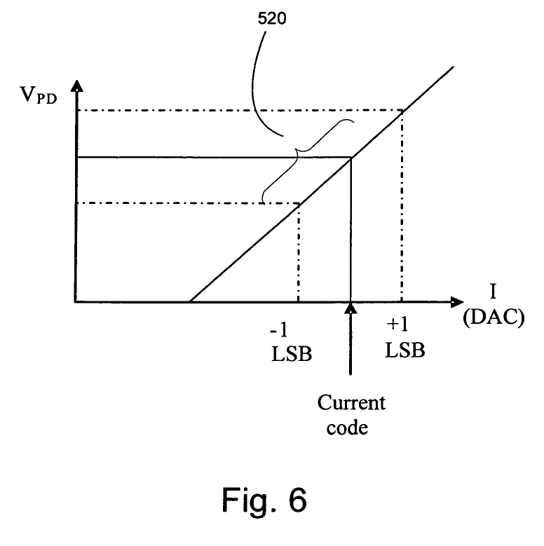

Referring to FIG. 6, the excitation ratio slope may be monitored in real-time by the micro-controller 502. According to an embodiment, the microcontroller 502 may periodically dither (i.e., increase or decrease) the current code 510 by, for example, ±1 LSB driving current without appreciable interference to the main VCSEL 321 operation. However, slight variation in VSCEL output power caused by this ±1LSB change may be detected by an output voltage variation V_{PD} of the PD 325 to reflect the difference in the laser average power. In one embodiment, the microcontroller 502 may increase and decrease the current code 510 by ±1 LSB for example anywhere from 500-1500 times a second. Of course this number may be selected to be different according to the application. Signal V_{PD} feeds into the microcontroller 502 such that a representation of the excitation ratio slope efficiency 520 may be determined in real time. According to one embodiment, the slope efficiency may be determined by:

$$SlopeEfficiency ( η ) = \frac{{V}_{pd} ( current code + 1 LSB ) - {V}_{pd} ( current code - 1 LSB ) .}{I ( current code + 1 LSB ) - I ( current code - 1 LSB )}$$

Knowing real time excitation ratio slope efficiency then allows the microcontroller to adjust the current code to correspondingly adjust the drive current 508 driving the VCSEL 321 to maintain a substantially constant slope over various ambient temperature and conditions, thus eliminating use of EEPROM look-up tables and the drawbacks associated therewith.

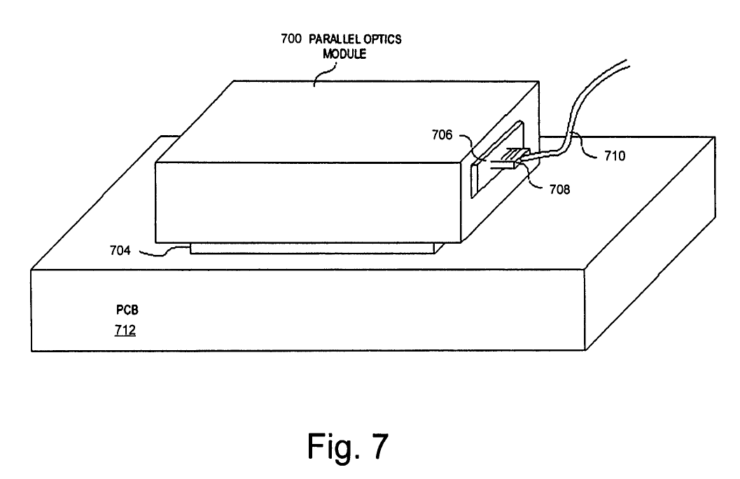

FIG. 7 illustrates embodiments of the invention used in a parallel optics module 700 coupled to a printed circuit board (PCB) 712. Parallel optics module 700 may include drive controls and VCSEL TOSAs as previously described for example with relation to FIG. 5. Parallel optics module 700 may include an optical transmitter, an optical receiver, or an optical transceiver.

Parallel optics module 700 includes an electrical connector 704 to couple module 700 to PCB 712. Electrical connector 704 may include a ball grid array (BGA), a pluggable pin array, a surface mount connector, or the like.

Parallel optics module 700 may include an optical port 706. In one embodiment, optical port 706 may include an optical port comprising for example the SFF connector shown in FIG. 2 or may be adapted to receive a Multi-Fiber Push On (MPO) connector 708. MPO connector 708 may be coupled to an optical fiber ribbon 710. In one embodiment, the optical fiber ribbon 710 includes two or more plastic optical fibers.

In one embodiment, the VCSELs within the parallel optics module 700 may emit light at different wavelengths for use in Wavelength Division Multiplexing (WDM). In one embodiment, parallel optics module 700 may transmit and/or receive optical signals at approximately 850 nanometers (nm). In another embodiment, parallel optics module 700 may operate with optical signals having a transmission data rate of approximately 3-4 Gigabits per second (Gb/s) per channel. In yet another embodiment, optical signals transmitted and received by parallel optics module 700 may travel up to a few hundred meters. It will be understood that embodiments of the invention are not limited to the optical signal characteristics described herein.

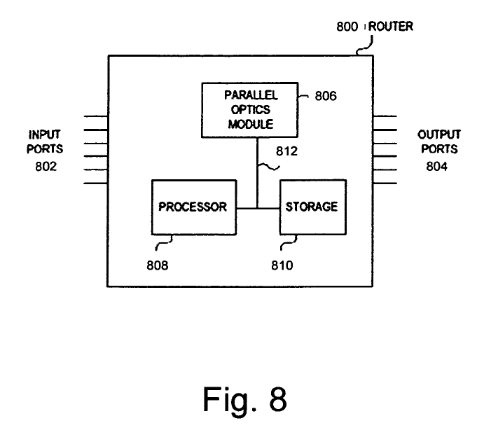

FIG. 8 illustrates an embodiment of a router 800. Router 800 includes a parallel optics module 806 as described above. In another embodiment, router 800 may be a switch, or other similar network element. In an alternative embodiment, parallel optics module 806 may be used in a computer system, such as a server.

Parallel optics module 806 may be coupled to a processor 808 and storage 810 via a bus 812. In one embodiment, storage 810 has stored instructions executable by processor 808 to operate router 800.

Router 800 includes input ports 802 and output ports 804. In one embodiment, router 800 receives optical signals at input ports 802. The optical signals are converted to electrical signals by parallel optics module 806. Parallel optics module 806 may also convert electrical signals to optical signals and then the optical signals are sent from router 800 via output ports 804. According to embodiments of the invention, the ER slope efficiency of the lasers within the router 800 may be maintained in real time across a broad ambient temperature range.

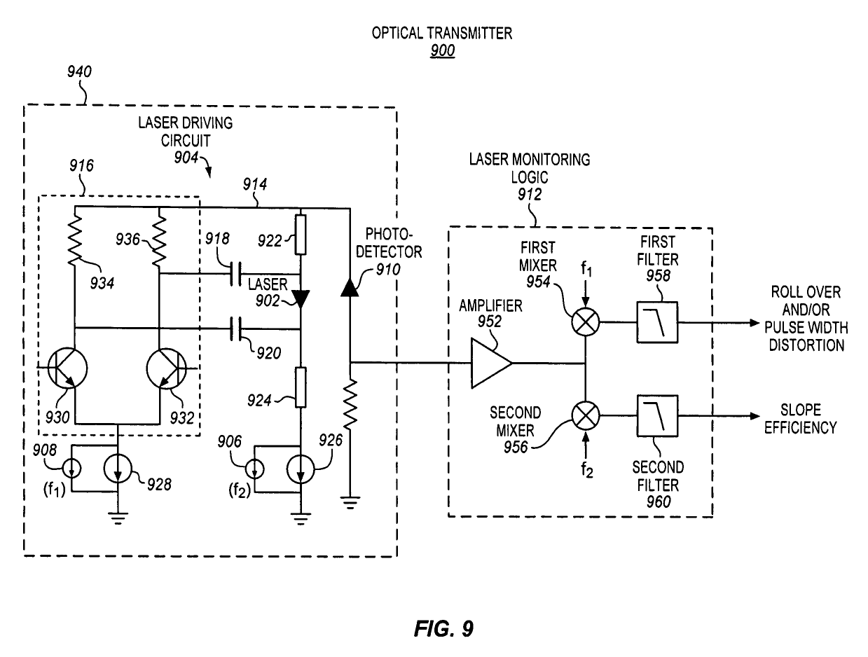

FIG. 9 is a block diagram of an optical transmitter 900, according to one or more embodiments of the invention. The optical transmitter includes a laser 902 to emit light, and a laser driving circuit 904 to provide a driving current to the laser. Perturbation circuits 906, 908 to provide different perturbation currents to the laser. The optical transmitter also includes a photodetector 910 to detect light emitted by the laser while the different perturbation currents are provided to the laser. Laser monitoring logic 912 is included, either as part of the optical transmitter or otherwise, to monitor operation of the laser in real time based, at least in part, on light detected by the photodetector while the different perturbation currents are provided to the laser.

The optical transmitter includes the laser 902 to emit light. Examples of suitable lasers include, but are not limited to, Fabret-Perot lasers, VCSELs, other types of laser diodes known in the arts.

The optical transmitter also includes the laser driving circuit 904 to provide a driving current to drive the laser. The laser driving circuit includes a bias current circuit to provide a bias current to the laser and a modulation current circuit to provide a modulation current to the laser.

The laser may emit light having a power or intensity that is directly related to the combination of the bias and modulation currents. The laser may be controlled to emit either a low optical power or a high optical power. The high optical power may, for example, correspond to a digital “1”, and the low optical power may, for example, correspond to a digital “0”. In certain cases, the modulation current may be added to a substantially constant bias current in order to cause the laser to emit light at the high optical power, and the modulation current may be subtracted from the bias current in order to cause the laser to emit light at the low optical power, although the scope of the invention is not limited in this respect. The laser may alternate between emitting low and high optical powers in order to communicate a string of zeroes and ones representing digital information. The modulation current may be rapidly modulated to cause the laser to provide a high-speed optical data stream.

A particular example of a suitable laser driving circuit is illustrated, although the scope of the invention is not limited to this particular circuit. Other laser driving circuits known in the art may alternatively optionally be used. The illustrated laser driving circuit includes a current supply line 914, a differential pair 916, an alternating current (AC) coupling cap 918, 920, AC blocking inductors 922, 924, a bias current regulator 926, and a modulation current regulator 928.

Current flows from the current supply line, such as, for example, a V_{cc} line, into the remainder of the laser driving circuit. In particular, a bias current flows from the current supply line, through the AC block inductors, through the laser, and through the bias current regulator. The AC block inductors may help to shield the laser from AC current from the differential pair.

A modulation current flows from the current supply line through the differential pair, through the laser, and through the modulation current flow regulator. The differential pair includes a pair of bipolar transistors 930, 932 and a pair of resistors 934, 936. The bipolar transistors are electrically coupled in parallel with one another. Likewise, the resistors are electrically coupled in parallel with one another. Each of the bipolar transistors is electrically coupled in series with one of the resistors. The differential pair may modulate the current received from the current supply line, generally at high speed or frequency, such as, for example, to provide a high-speed optical data stream.

The AC coupling cap is electrically coupled with the differential pair and electrically coupled across the laser. The AC coupling cap includes a first capacitor 918 and a second capacitor 920. The first capacitor is electrically coupled with an input of the laser and electrically coupled between a first corresponding pair of a first resistor 936 and a first biopolar transistor 932 of the differential pair. The second capacitor is electrically coupled with an output of the laser and electrically coupled between a second corresponding pair of a second resistor 934 and a second biopolar transistor 930 of the differential pair. At high frequencies, the capacitors may behave like a short circuit. The first capacitor may couple modulation current into the laser. The second capacitor may couple modulation current out of the laser. The capacitors may help to shield the laser from non-AC currents of the differential pair.

The bias current regulator may regulate the amount of bias current that flows through the laser. Likewise, the modulation current regulator may regulate the amount of modulation current that flows through the laser. The regulators may behave like current control valves. In one or more embodiments of the invention, the current regulators may include circuits having a configurable or variable number of switched on transistors in parallel in order to provide configurable or variable current regulation.

In accordance with one or more embodiments of the invention, one or more small, low frequency perturbation currents may be provided to the laser in addition to the standard laser driving current in order to allow the operation of the laser to be monitored in real time. As will be discussed in further detail below, the laser may be monitored for slope efficiency, roll over, pulse width distortion, combinations thereof, or other operational characteristics entirely.

Referring again to FIG. 9, in one or more embodiments of the invention, the optical transmitter may include one or more perturbation circuits 906, 908 to provide one or more perturbation currents to the laser. As shown in the illustrated embodiment, the optical transmitter may include a bias current perturbation circuit 906 to provide a variable bias perturbation current to the laser, and a modulation current perturbation circuit 908 to provide a variable modulation perturbation current to the laser. However, it is not required that the optical transmitter include both the bias and modulation current perturbation circuits. Alternate optical transmitters are contemplated which may optionally include the bias current perturbation circuit without the modulation current perturbation circuit. Still other alternate optical transmitters are contemplated which may optionally include the modulation current perturbation circuit without the bias current perturbation circuit.

In the illustrated embodiment, the bias and modulation current perturbation circuits are electrically coupled with the laser driving circuit, although this is not required. For example, in an alternate embodiment, the perturbation circuits may be directly coupled with the laser, such as, for example, directly between the current supply line and the laser. In the illustrated embodiment, the bias and modulation current perturbation circuits are respectively coupled across the bias and modulation current regulators. The perturbation circuits may represent variable current regulators, such as, for example, electrical switches, that may provide variable amounts of perturbation current to the laser. For example, the perturbation circuits may be switched on or to a first state to allow additional respective bias and modulation currents to flow from the current supply line through the laser, or switched off or to second (not necessarily off) state to stop or reduce the flow of the additional respective bias and modulation currents through the laser. The term “off” is intended to encompass the possibility of some leakage. The current regulating electrical switches may function as variable current control valves that may be controlled to allow different amounts of additional perturbation current to flow through the laser. In one or more embodiments of the invention, the perturbation circuits may each include a circuit having transistors electrically coupled in parallel. The transistors may be switched on to allow an additional perturbation current to flow through the laser or switched off to stop the flow of the additional perturbation current. Alternatively, a portion of the transistors may remain on, and only another portion of the transistors may be switched on and off.

In one or more embodiments of the invention, the perturbation currents may represent relatively small and relatively low frequency currents. The perturbation currents are generally large enough to have a detectable affect on the light detected by the photodetector in order to allow monitoring, but small enough that they don't compromise the operation of the laser for its intended purpose. Often, the bias and modulation perturbation currents may be only a small fraction of the respective bias and modulation currents to which they are applied. By way of example, in various embodiments of the invention, the bias and modulation perturbation currents may range from about 0.1 to 10%, or from about 0.5 to 5%, or from about 0.5 to 2%, of the respective bias and modulation currents to which they are applied, although this is not required. In one particular embodiment of the invention, the bias perturbation current may be about 1% of the bias current, and the modulation perturbation current may be about 1% of the modulation current, although the scope of the invention is not so limited.

The perturbation currents are generally relatively low frequency compared to the standard modulation frequency of the laser. In other words, the perturbation currents are generally modulated or changed less rapidly than the laser is modulated. In one or more embodiments of the invention, a constant perturbation current may be persistently or continuously applied for a large number of consecutive modulation cycles. As used herein, a large number of modulation cycles means at least 100 modulation cycles. By way of example, in high-speed optical communications, the modulation current may be changed very rapidly, such as, for example, at rates corresponding to at least 1 Gbps (gigabits per second), at least 2 Gbps, at least 4 Gbps, around 10 Gbps, or higher. In various embodiments of the invention, the bias and/or modulation perturbation currents may be persistently or constantly applied for a period of time sufficient to convey at least 100, or at least 1000, or at least 10,000, or at least 100,000, at least 500,000, or more than 500,000 bits of digital information, to name just a few examples. Looking at this in a alternate way, in various embodiments of the invention, the bias and/or modulation perturbation currents may be persistently or constantly applied during at least 100, or at least 1000, or at least 10,000, or at least 100,000, at least 500,000, or more than 500,000 consecutive modulation cycles. In one particular embodiment of the invention, the ordinary modulation rate of the laser may be about 10 GHz, and modulation rate of the perturbation currents may be in the range of about 1 KHz to 1000 KHz, although the scope of the invention is not so limited.

The laser may receive the laser driving current representing the combination of the bias and modulation currents, plus any one or more applied perturbation currents. The laser may emit light of a power or intensity that is directly related to the total current received. For example, the laser may emit a higher power or intensity of light if a higher total current is received, and the laser may emit a lower power of light if a lower total current is received. Accordingly, the power or intensity of light emitted by the laser may depend, at least in part, on whether or not one or more perturbation currents have been applied, and upon magnitude of the one or more perturbation currents applied.

The photodetector 910 of the optical transmitter may be positioned or otherwise configured to receive and detect a portion of the light emitted by the laser. As shown, in one or more embodiments of the invention, the photodetector may be included proximate the laser in a package or assembly, such as, for example, a transmitter optical sub-assembly (TOSA) 940, although this is not required.

Examples of suitable photodetectors include, but are not limited to, avalanche photodiodes, photomultiplier tubes, p-n photodiodes, p-i-n photodiodes, and other miniature semiconductor photodetectors known in the arts. Such photodetectors may tend to have a response time that is slower than the high-speed modulation rate of the laser. As a result, such photodetectors may tend to detect average laser power over several modulation cycles.

The photodetector may provide a corresponding output electrical signal, such as, for example, a voltage, that may represent the detected average laser power. The magnitude of the electrical signal may be directly related to the detected average laser power, which may depend in part on whether or not a perturbation current has been applied.

The output electrical signal of the photodetector, or a representation thereof, may be provided to the laser monitoring logic 912. The laser monitoring logic may process the electrical signal in order to monitor the operation of the laser in real time based, at least in part, on a detected change in the average power of the light detected by the photodetector as a result of the application of one or more perturbation currents.

A particular example of a suitable laser monitoring logic is shown, although the scope of the invention is not limited to this particular laser monitoring logic. The illustrated laser monitoring logic includes a circuit, although this is not required. In one or more embodiments of the invention, the circuit may be included as a discrete integrated circuit separate from a TOSA in an optical transceiver along with the TOSA, although this is not required. In alternate embodiments, the laser monitoring logic may be implemented in software, such as, for example, instructions that may be executed by a processor or other circuit, or in a combination of hardware and software.

The illustrated circuit of the laser monitoring logic includes a particular example of a suitable lock-in amplifier, although other conventional lock-in amplifiers known in the arts may alternatively optionally be used. Lock-in amplifiers similar to that shown have been used in radio communication for many years. The lock-in amplifier may amplify and lock-in on a change in the electrical signal representing average power detected by the photodetector as a result of a change in a perturbation current by rejecting noise outside of a frequency of change of the perturbation current.

The illustrated lock-in amplifier includes an amplifier 952, a first mixer 954, a second mixer 956, a first filter 958, and a second filter 960. Alternatively, the amplifier may have either one but not both of the mixers. The amplifier may receive the electrical signal from the photodetector and may amplify or otherwise increase the magnitude of the received electrical signal. The amplifier may provide a resulting amplified electrical signal as output to each of the first mixer and the second mixer.

Frequencies associated with the perturbation currents may also be provided to the mixers as reference frequencies. In particular, the frequency of the modulation perturbation current (f₁) may be provided as a reference frequency to the first mixer. Likewise, the frequency of the bias perturbation current (f₂) may be provided as a reference to the second mixer. The reference signals may set the passband regions of the filters. The first mixer may reject noise outside of the modulation perturbation current (f₁) for improved detection of the affect of the modulation perturbation current on the average laser power. Likewise, the second mixer may reject noise outside of the bias perturbation current (f₂) for improved detection of the affect of the modulation perturbation current on the average laser power.

Each of the mixers may represent a conventional mixer such as those used in conventional radio circuits that may receive a plurality of input signals and provide a corresponding output signal. In one or more embodiments of the invention, the mixers may include multipliers that may multiply the amplified signal from the photodetector by the reference signal. Multiplication of two waveforms may result in the sum and difference of frequencies. Since the input signal and the reference signal may have the same frequency, the difference frequency may be zero. A direct current output may be proportional to the amplitude of the input signal and the cosine of the phase difference between the input and reference signals. The phase difference between the input signal and the reference signal may be zero, or may be adjusted to zero, so that the direct current output level from the multiplier may be proportional to the input signal. Since the various noise components on the input signals may have different frequencies than the reference signals supplied to the mixers, the sum and difference frequencies may tend to be non-zero and generally do not contribute significantly to the magnitude of the output signal. This magnitude of the output signal may be recovered by passing the output from the mixers through filters to remove the processed noise. In this way the mixer may detect a change in the electrical signal representing average power as a result of the applied perturbation current.

As shown, an output of the first mixer may be provided to a first filter, such as, for example, a low-pass filter. The first filter may filter the signal to reject or at least reduce noise. This may facilitate detection of changes in the average power of the laser detected by the photodetector as a result of the modulation perturbation current. Likewise, an output of the second mixer may be provided to a second filter, such as, for example, a low-pass filter. The second filter may filter the received signal, which may help to reject or reduce noise. This may facilitate detection of changes in the average power detected by the photodetector as a result of the bias perturbation current. Accordingly, the lock-in amplifier may function as a narrow bandpass filter and other narrow bandpass filters known in the arts may optionally alternatively be used.

A simple analogy to radio may help to illustrate certain concepts. In function, the lock-in amplifier may be tuned to listen to a particular frequency similarly to the way a radio may be tuned to a particular station. Each of the input reference frequencies may be used to tune the lock-in amplifier to the relevant frequency similar to the way a dial may be used to tune a radio to a particular station. Once tuned to the particular frequency, the lock-in amplifier may receive a signal corresponding to that particular frequency and reject signals or noise corresponding to other frequencies similarly to the way a radio receives a signal for a particular station but not other stations. It is to be appreciated that this is just a simple analogy for purposes of illustration and should not be taken to literally.

Now, in one or more embodiments of the invention, different frequencies or modulation rates may optionally be used for the bias and modulation perturbation currents, such as, for example to allow multiple operating characteristics of the laser to be monitored concurrently or at the same time, although this is not required. In one or more embodiments of the invention, the bias and modulation perturbation currents may differ by at least 5 KHz. For example, in one or more embodiments of the invention, the bias and modulation perturbation currents each range from about 1 to 1000 KHz and differ from one another by at least 5 or 10 KHz, although the scope of the invention is not so limited. This may allow changes in laser average power due to perturbations in both the modulation and bias currents to be processed concurrently for purposes of laser monitoring, but is optional and not required. As another option, affects of perturbed bias and modulations may be processed in series, and the frequencies of the bias and modulation perturbation currents may optionally be the same.

The laser monitoring logic may communicate monitored laser status to another component, such as, for example, a microcontroller included in an optical transceiver along with the optical transmitter. Examples of suitable laser status that may be communicated includes, but is not limited to, a change in the electrical signal representing light detected by the photodetector as a result of a change in bias perturbation current, a change in the electrical signal representing light detected by the photodetector as a result of a change in modulation perturbation current, and combinations thereof.

The microcontroller or other component may process the laser status in order to further monitor the performance of the laser in real time. In one or more embodiments of the invention, the microcontroller may also optionally receive other information, such as, for example, a temperature associated with the laser measured by a temperature measurement device in the TOSA or otherwise configured to measure a temperature of the laser. In one or more embodiments of the invention, the microcontroller may estimate or otherwise determine operating characteristics of the laser. Examples of suitable operating characteristics that may be determined include, but are not limited to, a slope efficiency of the laser, a roll over current or condition, and a pulse width distortion current or condition. Alternatively, the aforementioned laser monitoring logic may optionally be adapted to include logic to perform such processing, or else the laser monitoring logic and the microcontroller may be optionally combined.

In one or more embodiments of the invention, the microcontroller may alter control of the laser based, at least in part, on the communicated status and/or based on the determined operating characteristics of the laser. As a first example, the microcontroller may control a change, such as, for example, an increase, in bias current in order to compensate for a corresponding change, such as, for example, a decrease, in slope efficiency. As a second example, the microcontroller may control a decrease in a bias current and/or a modulation current when a roll over current or condition is detected in order to move the laser out of the roll over current or condition. As a third example, the microcontroller may control an increase in a bias current and/or a modulation current when a pulse width distortion current or condition is detected in order to move the laser out of the pulse width distortion current or condition. These are just a few non-limiting examples of control actions that may be taken by the microcontroller based on monitoring as disclosed herein.

The operational characteristics of the laser may be monitored as described elsewhere herein continuously, or when currents or temperatures change, or when the operational characteristics may otherwise be suspected to have changed. In one or more embodiments of the invention, the monitoring may be performed more frequently when laser temperatures are changing rapidly, such as, for example, during startup or when ambient temperatures are variable, and less frequently when laser temperatures are stable or constant. By way of example, if laser temperatures are changing rapidly, the monitoring and adjustment may be performed at least once a second, whereas if the laser temperatures are stable, several or tens of seconds may lapse between monitoring and adjustment is repeated. These are just a few examples.

Now detailed examples of determining several exemplary laser operating characteristics will be discussed. First, determination of a slope efficiency of the laser will be discussed. Then, determination of a roll over current or condition will be discussed. Finally, determination of a pulse width distortion current or condition will be discussed.

Slope efficiency is a parameter of a laser that may potentially change, such as, for example, due to changes in temperature, or due to aging of the laser, due to manufacturing variation, or due to other causes. In one or more embodiments of the invention, slope efficiency may be determined in real time during operation of a laser.

A method, according to one or more embodiments of the invention, may include applying a small, low frequency bias perturbation current to the laser using a bias current perturbation circuit as disclosed herein. An average power of light emitted by the laser over a plurality of laser modulation pulses while the perturbation is applied may be determined using a photodetector. Then, the magnitude of the bias perturbation current may be reduced, such as, for example, to zero. An average power of light emitted by the laser over a plurality of laser modulation pulses after the reduction in the perturbation current may be determined using a photodetector. Next, a slope efficiency of the laser may be determined based, at least in part, on a change in the average power of light detected before and after the reduction of the low frequency bias perturbation current relative to the amount of reduction in the low frequency bias perturbation current.

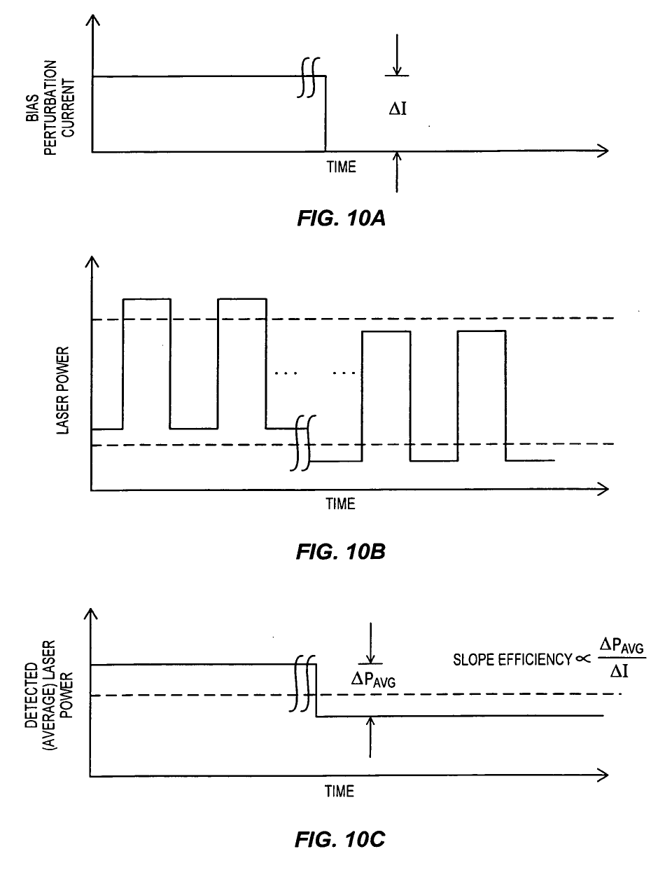

FIG. 10A-C show how a slope efficiency of a laser may be determined in real time by determining a change in average laser power relative to a change in a small, low frequency bias perturbation current, according to one or more embodiments of the invention. Events in FIGS. 10A-C correspond in time to one another.

FIG. 10A is a graph plotting bias perturbation current versus time, according to one or more embodiments of the invention. As shown, a bias perturbation current may initially be applied at a first level, such as, for example, a high level. The bias perturbation current may be continuously applied or maintained at this first level for a large number of modulation cycles, such as, for example in one instance on the order of 100,000 modulation cycles, in order to allow the photodetector to estimate of the average power of the laser when the bias perturbation current is at the first level.

Then, the bias perturbation current may be changed to a second level, such as, for example, reduced to a lower level. As shown, in one or more embodiments of the invention, the low level may have substantially zero current, although this is not required. The change in bias perturbation current (ΔI) between the low and high levels represents a change in the amount of perturbation that is applied to the bias current in order to determine parameters of the laser. The change in current is generally only a small fraction of the bias current to which it is applied. For example, in various embodiments of the invention, the bias perturbation current may range from about 0.1 to 10%, or from about 0.5 to 5%, or from about 0.5 to 2%, of the bias current to which it is applied. The bias perturbation current may be applied at this second level for a similar large number of modulation cycles, such as, for example, on the order of 100,000 modulation cycles.

FIG. 10B is a graph plotting actual laser power versus time, according to one or more embodiments of the invention. As shown, multiple modulation cycles or pulses may pass as the lower frequency bias perturbation current is applied. As further shown, both the low laser power and the high laser power drop in approximately the same proportion after the bias perturbation current is reduced to the lower level.

FIG. 10C is a graph plotting detected average laser output power versus time, according to one or more embodiments of the invention. As shown, when the higher level of the bias perturbation current is applied, the detected average laser output power is higher than when the lower level or zero bias perturbation current is applied. As a result of the decrease in the bias perturbation current, there is a decrease or change in the detected average laser output power (ΔP_{AVG}).

In one or more embodiments of the invention, the slope efficiency of the laser may be determined, based at least in part, on the ratio of the change in the detected average laser output power (ΔP_{AVG}) to the change in the bias perturbation current (ΔI). The ratio (ΔP_{AVG})/(ΔI) tends to be proportional to the slope efficiency. A decrease in the ratio indicates a decrease in the slope efficiency, whereas an increase in the ratio represents an increase in the slope efficiency. In one or more embodiments of the invention, if a determination is made that the slope efficiency has decreased from before, the bias current and/or modulation currents may optionally be increased to at least partially offset the decrease in the slope efficiency.

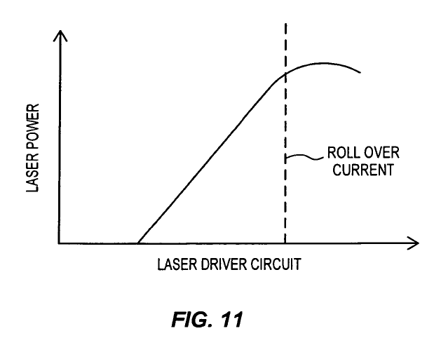

FIG. 11 is a graph plotting laser power versus drive current that illustrates a roll over current or condition, according to one or more embodiments of the invention. Laser driver current is plotted on the x-axis and actual laser output power is plotted on the y-axis.

As shown, the laser may have a low threshold current before which appreciable light is emitted by the laser. The threshold current is illustrated in the graph as the interception of the plot with the x-axis. Once the laser driver current is greater than the threshold current, the output power of the laser may tend to increase substantially linearly with increasing laser driver current. The slope of the line represents the ratio of the change in laser power per corresponding change in laser driver current. This slope is commonly known in the arts as the slope efficiency. Lasers used in digital communications are often operated in this linear region.

As the laser driver current is further increased, at some point a roll over current or condition may occur. As shown, an abrupt termination of the linear region of operation may occur as the laser driver current meets or exceeds the roll over current. In particular, as the laser driver current reaches or exceeds the roll over current, the ratio of the change of laser output power per corresponding change of input laser driver current may significantly decrease. In some cases, the laser output power may begin to decrease as the laser driver current is further increased. Various types of lasers, such as, for example, Fabret-Perot lasers, VCSELs, and other types of laser diodes or semiconductor lasers, may tend to experience such a roll over condition, such as, for example, when they are operated at sufficiently high drive current, when they are operated at sufficiently high temperatures, and/or when they are otherwise overheated.

Lasers used in digital communications are often operated in the linear region. However, the laser driver current may be increased due to various potential reasons, such as, for example, to compensate for a decrease in slope efficiency with increasing temperature. In some cases, the laser driver current may reach or exceeds the roll over current. In such cases, the operational characteristics of the laser may significantly change. Often, this significant change may be undesirable. It may be appropriate to be able to determine when the roll over current or condition is reached in real time, such as, for example, to control the laser to move away from the roll over condition.

A conventional approach for dealing with roll over may include rigorously measuring the roll over current of a particular laser at different conditions, such as, for example, at different temperatures. The measured roll over currents at the different conditions may be stored in a look-up table indexed by the different conditions. The look-up table may be stored in a memory, such as, for example, an EEPROM, in an optical transceiver incorporating the laser. However, one potential drawback with such an approach is that making such measurements may tend to be inaccurate, costly, and/or time consuming. Another potential drawback is that the provision of the memory may add to the cost of the device. Yet another potential drawback is that it may be difficult to detect roll over when the laser ages, degrades, or otherwise changes.

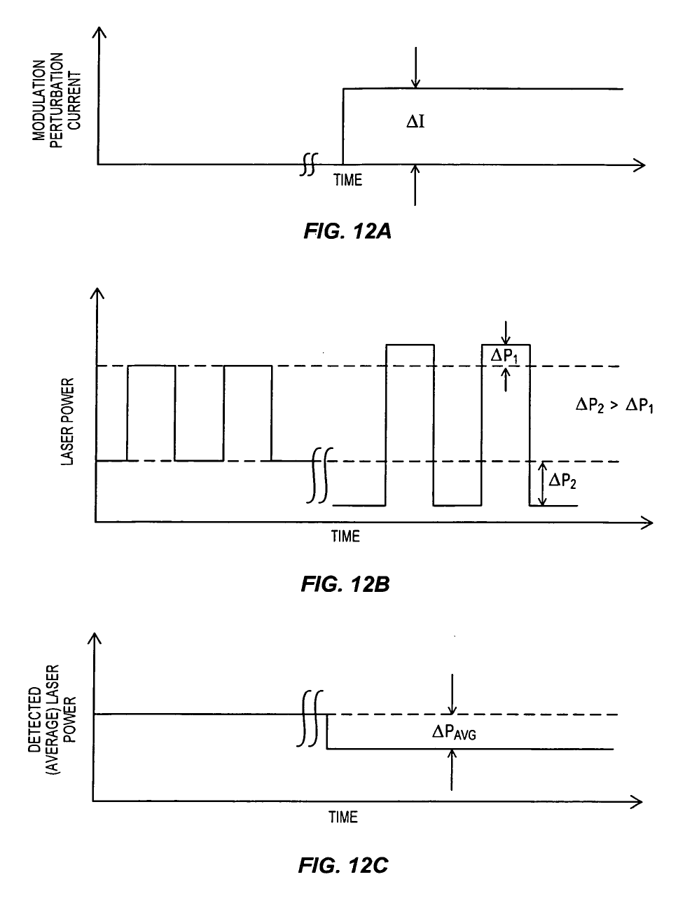

FIG. 12A-C show how a roll over current or condition may be determined or detected in real time by detecting a change in average laser power as a result of a change in a small, low frequency modulation perturbation current, according to one or more embodiments of the invention.

FIG. 12A is a graph plotting modulation perturbation current versus time, according to one or more embodiments of the invention. As shown, a modulation perturbation current may initially be applied at a first level, such as, for example, in the illustration a low level or zero. The modulation perturbation current may be continuously applied or maintained at this first level for a large number of modulation cycles, such as, for example in one instance on the order of about 100,000 modulation cycles, in order to allow the photodetector to estimate of the average power of the laser when the modulation perturbation current is at the first level.

Then, the modulation perturbation current may be changed to a second level, such as, for example, in the illustration increased to a higher non-zero level. In various embodiments of the invention, the change in modulation perturbation current (ΔI) between the low and high levels may range from about 0.1 to 10%, or from about 0.5 to 5%, or from about 0.5 to 2%, of the modulation current used to drive the laser. The bias perturbation current may be applied at this second level for a similar large number of modulation cycles.

FIG. 12B is a graph plotting actual laser output power versus time, according to one or more embodiments of the invention. When the modulation perturbation current is applied at the low level, the total current is below the roll over current. However, when the modulation perturbation current is applied at the high level, the total current may reach or exceed the roll over current or condition. As shown, both the laser low power and the laser high power may change as a result of the application of the modulation perturbation current. As further shown, the change in the laser low power (ΔP₂) may be greater than the change in the laser high power (ΔP₁), since the higher current may have reached or exceeded the roll over current. As a result, the average laser power detected by the photodetector over multiple modulation cycles may decrease.

FIG. 12C is a graph plotting detected average laser output power versus time, according to one or more embodiments of the invention. As shown, there may be a change (decrease) in the detected average laser output power (ΔP_{AVG}) when the modulation perturbation current is changed (increased).

Roll over tends to occur at high temperatures, and/or high currents, and/or when the laser is otherwise on the verge of overheating. In one or more embodiments of the invention, upon detecting such a change, a determination may be made whether or not the temperature of the laser is greater than a predetermined temperature, such as, for example, a median design temperature, or a temperature at which roll over condition tends to become a problem, such as, for example about 70° C. for some types of lasers. If the temperature is determined to be greater than this predetermined temperature, then in one or more embodiments of the invention, the change in the detected average power may be inferred to be indicative of a roll over condition or current. In such cases, in one or more embodiments of the invention, a microcontroller or other controller may control a reduction in the bias and/or modulation currents to move the laser away from the roll over current or condition.

Pulse width distortion currents or conditions may alternatively tend to occur at low temperatures, and/or low currents, and/or when the laser is otherwise on the verge of being underheated.

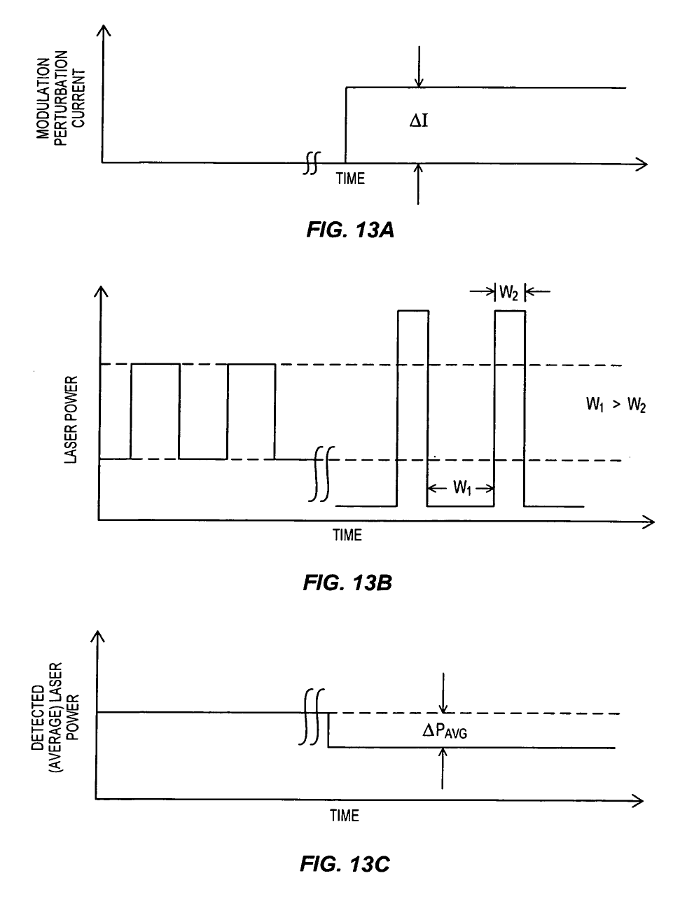

FIG. 13A-C show how a pulse width distortion current or condition may be determined or detected in real time by detecting a change in average laser power as a result of a change in a small, low frequency modulation perturbation current, according to one or more embodiments of the invention.

FIG. 13A is a graph plotting modulation perturbation current versus time, according to one or more embodiments of the invention. This plot is similar to that shown in FIG. 12A and will not be discussed in further detail.

FIG. 13B is a graph plotting actual laser output power versus time, according to one or more embodiments of the invention. When the modulation perturbation current is applied at the low level or zero, the total current is above the pulse width distortion current or condition. However, when the modulation perturbation current is applied at the high level, the low level modulations may dip below the pulse width distortion current. As shown, the low output power pulse width (W₁) of may be greater than the high output power pulse width (W₂). This may result in longer periods of time on average that the laser is in the low output power state. As a result, average output power of the laser such as that detected by the photodetector may tend to decrease.

FIG. 13C is a graph plotting detected average laser output power versus time, according to one or more embodiments of the invention. As shown, there may be a change (decrease) in the detected average laser output power (ΔP_{AVG}) when the modulation perturbation current is changed (increased).

Since pulse width distortion currents and conditions tend to occur at low temperatures, and/or low currents, and/or when the laser is otherwise on the verge of being underheated. In one or more embodiments of the invention, upon detecting such a change, a determination may be made whether or not the temperature of the laser is less than a predetermined temperature, such as, for example, a median design temperature, or a temperature at which pulse width distortion tends to become a problem, such as, for example about −10° C. for some types of lasers. If the temperature is determined to be less than this predetermined temperature, then in one or more embodiments of the invention, the change in the detected average power as a result of the change in the modulation perturbation current may be inferred to be indicative of a pulse width distortion condition or current. In such cases, in one or more embodiments of the invention, a microcontroller or other controller may control an increase in the bias and/or modulation currents to move the laser away from the pulse width distortion current or condition.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the sizes, configurations, functions, materials, and manner of operation of the components of the embodiments. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, computer systems, optical network devices, optical transceivers, and a wide variety of other devices having circuits, such as, for example, processors or microcontrollers, to name just a few examples.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention. Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
applying a perturbation current to a laser for a plurality of consecutive modulation cycles;
detecting power of light emitted by the laser over the plurality of consecutive modulation cycles;
changing the perturbation current;
detecting power of light emitted by the laser over a plurality of consecutive modulation cycles after changing the perturbation current;
determining an operating characteristic of the laser based, at least in part, on a change in the power of light detected before and after the change in the perturbation current.

2. The method of claim 1, wherein said determining comprises determining an operating characteristic selected from a slope efficiency, a roll over condition, and a pulse width distortion condition.

3. The method of claim 1:
wherein said applying comprises applying the perturbation current to a bias current; and
wherein said determining comprises determining a slope efficiency based, at least in part, on a ratio of the change in the power of the light detected before and after the change in the perturbation current to an amount of the change in the perturbation current.

4. The method of claim 1:
wherein said applying comprises applying the perturbation current to a modulation current; and
wherein said determining comprises determining a roll over condition based, at least in part, on a change in power detected at a temperature greater than a predetermined temperature.

5. The method of claim 1:
wherein said applying comprises applying the perturbation current to a modulation current; and
wherein said determining comprises determining a pulse width distortion condition based, at least in part, on a change in power detected at a temperature less than predetermined temperature.

6. The method of claim 1:
wherein said applying comprises applying a perturbation current that ranges from 0.1 to 10% of a current selected from a bias current and a modulation current to which it is applied; and
wherein said applying comprises applying the perturbation current for at least 100 modulation cycles.

7. The method of claim 1, wherein said reducing the perturbation current comprises switching off the perturbation current.

8. An apparatus comprising:
a laser;
a circuit to provide a bias current and a modulation current to the laser;
a perturbation circuit to provide different perturbation currents to the laser, wherein each of the different perturbation currents are provided for a plurality of consecutive modulation cycles;
a photodetector to detect light emitted by the laser while the different perturbation currents are provided to the laser;
logic to determine an operating characteristic of the laser based, at least in part, on light detected by the photodetector while the different perturbation currents are provided to the laser.

9. The apparatus of claim 8, wherein the logic comprises a lock-in amplifier.

10. The apparatus of claim 9, wherein the lock-in amplifier comprises:
an amplifier;
a mixer coupled with an output of the amplifier; and
a filter coupled with an output of the mixer.

11. The apparatus of claim 8, wherein the perturbation circuit comprises a plurality of transistors coupled in parallel.

12. The apparatus of claim 8:
wherein the perturbation circuit is to provide a perturbation current that ranges from 0.1 to 10% of a current selected from a bias current and a modulation current to which it is applied; and
wherein the perturbation circuit is to provide each of the different perturbation currents for at least 100 modulation cycles.

13. The apparatus of claim 8, wherein the operating characteristic is selected from a slope efficiency, a roll over condition, and a pulse width distortion condition.

14. The apparatus of claim 8:
wherein the perturbation circuit comprises a bias current perturbation circuit to provide different bias perturbation currents to the laser; and
wherein the logic comprises logic to determine a slope efficiency based, at least in part, on a ratio of a change in the light detected by the photodetector to a change in the bias perturbation currents.

15. The apparatus of claim 8:
wherein the perturbation circuit comprises a modulation current perturbation circuit to provide different modulation perturbation currents to the laser; and
wherein the logic comprises logic to determine a roll over condition based, at least in part, on a change in light detected by the photodetector at a temperature greater than a predetermined temperature.

16. The apparatus of claim 8:
wherein the perturbation circuit comprises a modulation current perturbation circuit to provide different modulation perturbation currents to the laser; and
wherein the logic comprises logic to determine a pulse width distortion condition based, at least in part, on a change in light detected by the photodetector at a temperature less than a predetermined temperature.

17. The apparatus of claim 8:
wherein the operating characteristic is selected from a slope efficiency, a roll over condition, and a pulse width distortion condition;
wherein the perturbation circuit is to provide a perturbation current that ranges from 0.1 to 10% of a current selected from a bias current and a modulation current to which it is applied;
wherein each of the different perturbation currents have a frequency in the rang of 1 to 1000 KHz; and
wherein the logic comprises a lock-in amplifier.

18. A system comprising:
a laser to emit light;
a laser driving circuit to provide a driving current to the laser;
a perturbation circuit to provide different perturbation currents to the laser, wherein each of the different perturbation currents are provided for a plurality of consecutive modulation cycles;
a photodetector to detect light emitted by the laser while the different perturbation currents are provided to the laser;
logic to determine an operating characteristic of the laser based, at least in part, on light detected by the photodetector while the different perturbation currents are provided to the laser; and
a plastic optical fiber optically coupled with the laser to receive light emitted by the laser.

19. The system of claim 18, wherein the logic comprises a lock-in amplifier.

20. The system of claim 18:
wherein the operating characteristic is selected from a slope efficiency, a roll over condition, and a pulse width distortion condition;
wherein the perturbation circuit is to provide a perturbation current that ranges from 0.5 to 5% of a current selected from a bias current and a modulation current to which it is applied; and
wherein each of the different perturbation currents are provided for at least 100 modulation cycles.
